(19) United States
(12) Patent Application Publication
(10) Pub. No.: US 2006/0273682 A1
(43) Pub. Date: Dec. 7, 2006

(54) Permanent-magnet generator with magnetic flux controls

(75) Inventor: Hideo Kawamura, Kouza-gun (JP)

Correspondence Address: BROWDY AND NEIMARK, P.L.L.C.;624 NINTH STREET, NW, SUITE 300, WASHINGTON, DC, 20001-5303, US

(73) Assignee: Fuji Cera-Tech Co., Ltd., Atsugi-shi (JP)

(21) Appl. No.: 11/447,113

(22) Filed: Jun. 6, 2006

(30) Foreign Application Priority Data
Jun. 7, 2005 (JP) 2005-166453

(51) Int. Cl. H02K 11/00; H02K 21/00; H02K 1/12

(52) U.S. Cl. 310/191; 310/68 R; 310/254; 322/46

(57) ABSTRACT

A permanent-magnet generator with flux control means, which has a device simple in construction to increase or decrease air gaps for flux path in response to an rpm of a rotor, regulating a magnetic flux flowing in a stator. The permanent-magnet generator is envisaged further curbing the magnetic flux flowing in the stator at high-speed rotation of the rotor, maintaining an output voltage of the generator within prescribed limits at any given time. The stator winding is made up of a three-phase output winding wound on the stator teeth and other three-phase flux regulator winding, the latter winding being reverse in winding direction to the former. The flux regulator winding is connected to the output winding through a flux regulator switch. With the permanent-magnet generator constructed as stated earlier, the on-off operation of the flux regulator switch conjoins with increase or decrease of the air gap for flux path by the flux regulator ring to maintain the output voltage of the generator within a prescribed voltage value.

### FIELD OF THE INVENTION

The present invention relates to a permanent-magnet generator that is comprised of a stator fastened inside a stator housing, a rotor with permanent magnets adapted to turn with respect to the stator, and a flux controller allowed to move in circular direction relatively to the stator to alter the air gap, thereby regulating the magnetic flux.

### BACKGROUND OF THE INVENTION

With most conventional permanent-magnet generators, there are commonly used any switching regulator to chop an electric current to keep generated voltages within the prescribed range that can be tolerated by the electric equipment using that voltage. Nevertheless, very large power-transistors are needed to switch a high voltage and/or large current between a conducting “on” state and a blocking “off” state. This would cause an increase in generator dimensions, in a heat loss or energy dissipated in cooling and further in production cost. Moreover, the large power-transistors are more likely to raise any radio blackout or radio noise caused by excessive inrush current that would develop when chopping the electric current to keep the generated voltage within a desired voltage range. Thus, the shortcomings as stated just earlier will pose some very difficult problems for the large power-transistors.

In the commonly assigned Japanese Patent Laid-Open No. 2003-264996, there is disclosed a permanent-magnet generator with self-voltage controls, in which a winding is located outside the generator to produce a braking voltage in coils, keeping constantly the generated voltage within prescribed limits. U-phase, V-phase and W-phase windings to develop a three-phase alternating current are each connected at their terminals through switching means with coils that have winding turns set in number of turns to maintain the generated voltage in the three-phase windings within acceptable limits. Terminals of the coils are in turn connected with any electric machinery. The coils are wound around a yoke in reverse directions to form the primary side of the transformer while other coils are wound around the yoke to form the secondary side and connected to an output terminal to deliver the voltage of the prescribed level.

Another commonly assigned Japanese Patent Laid-Open No. 2002-204556 discloses a motor-generator with magnetic flux controls in which there are provided three winding groups wound on teeth in a way differing in number of turns from one another. The magnetic flux controller operates to make position control of a cylindrical member relatively to a stator core and switching control between series and parallel connections in response to rpm of a rotor, maintaining the generated voltage within the prescribed limits. With the magnetic flux controller operated as stated earlier, the high voltage occurs when the winding groups are connected in series while the low-voltage with large amount of current is given when the winding groups are switched into parallel connection. The high voltage is derived from a winding conductor that is so tapped on a split-winding wound around a stator core as to reduce the winding turns in number as the rpm of the rotor rises. In the windings to develop the three-phase current, subdivided windings 1U, 2U and 3U; 1V, 2V and 3V; and 1W, 2W and 3W are each connected in series at their connection points that are connected through lines to switches. The flux controller constructed as stated earlier, depending on the rpm of the rotor, makes angular position control of the semi-circular member with respect to the stator and also switching control of the wiring configuration between the parallel and series connections, thereby making it possible to provide the three-phase alternating electric source of the prescribed alternating voltage.

In a further another commonly assigned Japanese Patent Laid-Open No. 2001-298926, there is disclosed a generator with two voltage ranges switched from one to the other to match the desired voltage of the electric equipment using the voltage. With the prior generator recited now, a stator is comprised of an inside circular member lying radially apart from an outside circular surface of a rotor to leave a clearance between them, the inside circular member being made with stator teeth spaced away from each other in circular direction to form slots sequential in circular direction, an outside circular member surrounding around the tooth tips of the stator teeth raised radially above the inside circular member, two systems of stator windings either distributed-wound or concentrated-wound around the teeth with spanning across preselected slots, one of which contains low power windings less in number of turns while another of which has high power windings more in number of turns, and terminal lines having terminals connected to any preselected low power and high power windings. The windings either distributed-wound or concentrated-wound around any field pole corresponding to the rotor pole are split from the series connection into some parallel connections as the rpm of the rotor rises to regulate the generated voltage, so that the generated voltage is regulated by turning on and off the switches connected to their associated wirings connected with the terminals of the windings.

As recited earlier with referring to three commonly assigned senior patent applications, the present inventor has worked toward a resolution of issues in the prior permanent-magnet generators. Consequently, the permanent-magnet generator was devel oped in which a ring to control magnetic flux is placed between a stator and a rotor to move in circular direction relatively to the stator. Circular movement of the flux control ring with respect to the stator causes to increase or decrease the clearance for the magnetic path between radially opposite teeth of the flux control ring and the stator, regulating the magnetic flux flowing towards the stator to keep the generated voltage within the prescribed range.

Nevertheless, there is still a major issue in the prior permanent-magnet generators to be worked out when the permanent-magnet generators are used especially in the land vehicles including automobiles, and so on in which the rotor experiences wide variation ranging over from full load to no load. The permanent-magnet generator, when associated with the automotive engine, would be suffered the variation in rpm ranging over from 10-fold up to 15-fold. Moreover, the permanent-magnet generators are needed to have a versatile generating capacity effective in wide operating conditions ranging over from idling to 7000 rpm and, therefore, it is not easy to keep the generated voltage within the preselected limits irrespective of operating condition of the automotive engine. Only the restricted clearance between the rotor and the stator, however, was limited in regulating the magnetic flux of the permanent magnet. As another approach to address the limitation as stated earlier, the present inventor has found that a reverse current flow applied to the magnetic path of the permanent magnet after the rpm of the rotor has risen is strongly in favor of the magnetic flux control to regulate the generated voltage within the acceptable limits.

### SUMMARY OF THE INVENTION

It is a primary object of the present invention to overcome the problems stated earlier and to further improve a permanent-magnet generator with magnetic flux control means that operates to increase or decrease a clearance for magnetic path between a rotor and a stator, thereby to provide a permanent-magnet generator with magnetic flux control means in which a three-phase winding for magnetic flux regulation is wound around a stator in a winding direc tion reverse to the winding direction of a three-phase output voltage winding laid around the stator, and a reverse field is produced in the winding for magnetic flux regulation to block a magnetic field flowing from the permanent magnet around the rotor into the stator, while on-off switching operation on each output line is carried out to keep the output voltage within an acceptable voltage limit prescribed depending on a rpm and a load.

The present invention is concerned with a permanent-magnet generator; comprising a rotating shaft supported for rotation in a stator housing, a rotor fastened on the rotating shaft and provided with a permanent magnet unit of permanent magnet strips positioned at an interval around the rotor, a stator installed inside the stator housing and provided with windings wound around teeth lying at an interval in a circular direction, a flux regulator ring lying between the stator and the rotor for circular movement relatively to the stator, and a flux regulator means operated to increase or decrease an air gap for flux path between the stator and the flux regulator ring to regulate a magnetic flux flowing in the stator; wherein the windings wound on the teeth of the stator are each composed of a three-phase output voltage winding wound on the teeth in any one winding direction and a three-phase flux regulating winding wound on the same teeth in another winding direction reverse to the winding direction of the output voltage winding; and wherein the flux regulating winding has an output line connected to an output line of the output voltage winding through a flux regulator switch, which is operated to turn on or off in response to variations in rpm of the rotor and in load to cause a reverse-field current in the output voltage winding, so that on-off operation of the flux regulator switch conjoins with increase or decrease of the air gap for flux path by the flux regulator means to maintain the output voltage of the generator within a prescribed voltage value.

In an aspect of the present invention, a permanent-magnet generator is disclosed in which the output voltage winding is shunt at midway location thereof with an intermediate output terminal, the output line for the output voltage winding has an output switch while the intermediate output line has an output-lowering switch, which is operated to turn on or off conversely to switching “on-off” of the output switch, and wherein the output switch, output-lowering switch and flux regulator switch are all operated to make switching “on-off” in response to both the rpm of the rotor and the variation in the load.

In another aspect of the present invention, a permanent-magnet generator is disclosed in which the flux regulator switch is turned on at high rpm of the rotor under partial loaded condition of the load to develop the reverse field current to curb a magnetic flux flowing in the stator through the flux regulator ring, and wherein the reverse field current is regulated automatically to increase as the load decreases.

In a further aspect of the present invention, a permanent-magnet generator is disclosed in which when the rotator is driven at high rpm while the load is under non-loaded condition, the flux regulating means is governed automatically in such a way rendering a resistance at the load infinite to permit a current to flow out of the output voltage winding into the flux regulator winding through the flux regulator ring, regulating the magnetic force so as to decrease the amount of generated power, and then further lowering the flow of the magnetic force down to nothing to thereby eventually stop the output voltage.

In another aspect of the present invention, a permanent-magnet generator is disclosed in which the output voltage winding and the flux regulator winding are connected with one another in a manner that a U-phase output line in the output voltage winding is connected with a U-phase output line on same pole in the flux regulator winding, a V-phase output line in the output voltage winding is connected with a V-phase output line on same pole in the flux regulator winding, and further a W-phase output line in the output voltage winding is connected with a W-phase output line on same pole in the flux regulator winding.

In another aspect of the present invention a permanent-magnet generator is disclosed in which the output voltage winding and the flux regulator winding are connected together in a manner that the output lines for poly-phase in the output voltage winding are each connected to the output line for backward phase in the flux regulator winding so as to match with a time lag when the field. Especially, if revolving fields of the rotor change in phase order of U-phase, V-phase and then W-phase, the U-phase output line in the output voltage winding is connected with the backward V-phase output line in the flux regulator winding, the W-phase output line in the output voltage winding is connected with the backward V-phase output line in the flux regulator winding, and further the V-phase output line in the output voltage winding is connected with the backward U-phase output line in the flux regulator winding.

With the permanent-magnet generator constructed as stated earlier, if the flux regulator winding is switched on at high rpm of the rotor with the load being under partial loading, the output voltage winding carries the generated current into the load while the flux regulator shunt-winding also carries the current to thereby develop a reverse-field current in the flux regulator winding so as to prevent the magnetic force from flowing out of the permanent magnet into the stator, causing the magnetic flux to decrease to lower the generated voltage, maintaining the output voltage of the generator within a prescribed limits. When the rotator is driven while the load is under non-loaded condition, all the currents are permitted flowing out of the output voltage winding into the flux regulator winding through the flux regulator ring to thereby stop the provision of the generated voltage.

Other objects and features of the present invention will be more apparent to those skilled in the art on consideration of the accompanying drawings and following specification wherein are disclosed preferred embodiments of the present invention with understanding that such variations, modifications and elimination of parts may be made therein as fall within the scope of the appended claims without departing from the spirit of the invention.

### BRIEF DESCRIPTION OF THE DRAWINGS

FIG. 1 is a circuit diagram explanatory of a preferred embodiment of a permanent-magnet generator with magnetic flux control means in accordance with the present invention;

FIG. 2 is a graphic representation showing current vs. voltage yielded by the magnetic flux control means shown in FIG. 1;

FIG. 3 is a circuit diagram explanatory of another version of a permanent-magnet generator with magnetic flux control means in accordance with the present invention;

FIG. 4 is a view in an axial section of the first version of the permanent-magnet generator in FIG. 1;

FIG. 5 is a view in transverse section of the permanent-magnet generator of FIG. 4 taken on the plane I-I of that figure, wherein a stator housing is shown removed to expose the geometric relation in which teeth inside a stator match closely in circular position with corresponding teeth around a flux regulator ring to not block magnetic flux;

FIG. 6 is a fragmentary enlarged view in transverse section of the permanent-magnet generator of FIG. 4 taken on the plane I-I of that figure, wherein a stator housing is shown removed to expose the geometric relation in which teeth inside a stator match closely in circular position with corresponding teeth around a flux regulator ring with causing no gaps between them, thereby remaining the magnetic flux unrestricted; and.

FIG. 7 is a fragmentary enlarged view in transverse section of the permanent-magnet generator of FIG. 4 taken on the plane I-I of that figure, wherein a stator housing is shown removed to expose the geometric relation in which teeth inside a stator move past in circular position away from corresponding teeth around a flux regulator ring to leave gaps between them to block magnetic flux.

### DETAILED DESCRIPTION OF THE PREFERRED EMBODIMENTS

A permanent-magnet generator with magnetic flux control means constructed according to the present invention is well adapted for installation to automotive engines in, for example the land vehicles including automobiles and so on in which the permanent-magnet generator will experience uccessively large variation in electric load.

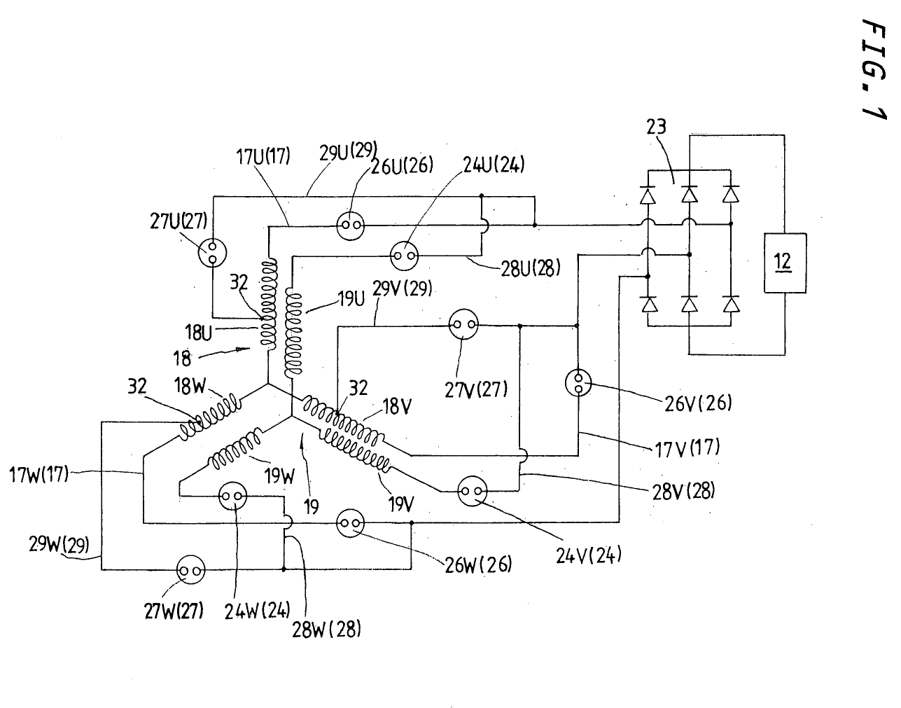

The permanent-magnet generator of the present invention will be described hereinafter with reference to the accompanying drawings. The present permanent-magnet generator according to the present invention is most suitable for generating output voltages from driving power of the automotive engine which would experience large variations in load. Preparatory to the explanation with reference to FIG. 1 of the permanent-magnet generator with magnetic flux control means constructed according to the present invention, the permanent-magnet generator to have mounted thereon with the magnetic flux control means is first explained below.

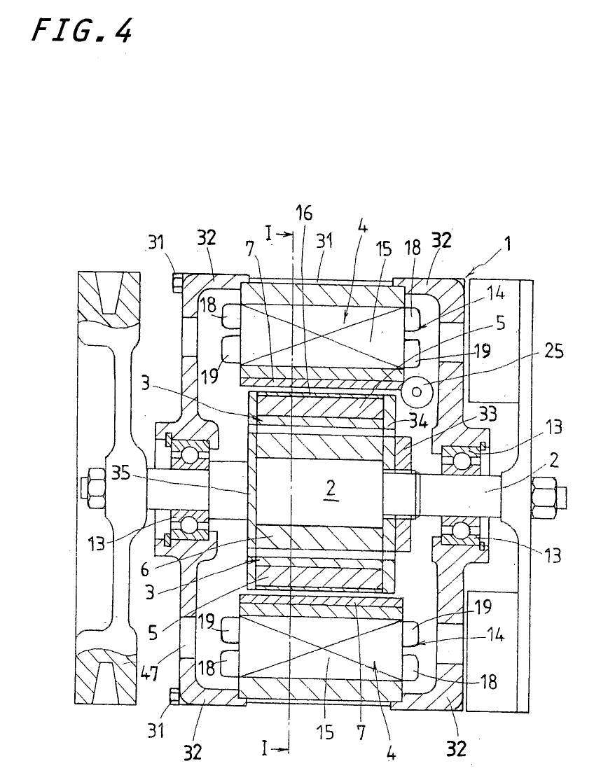

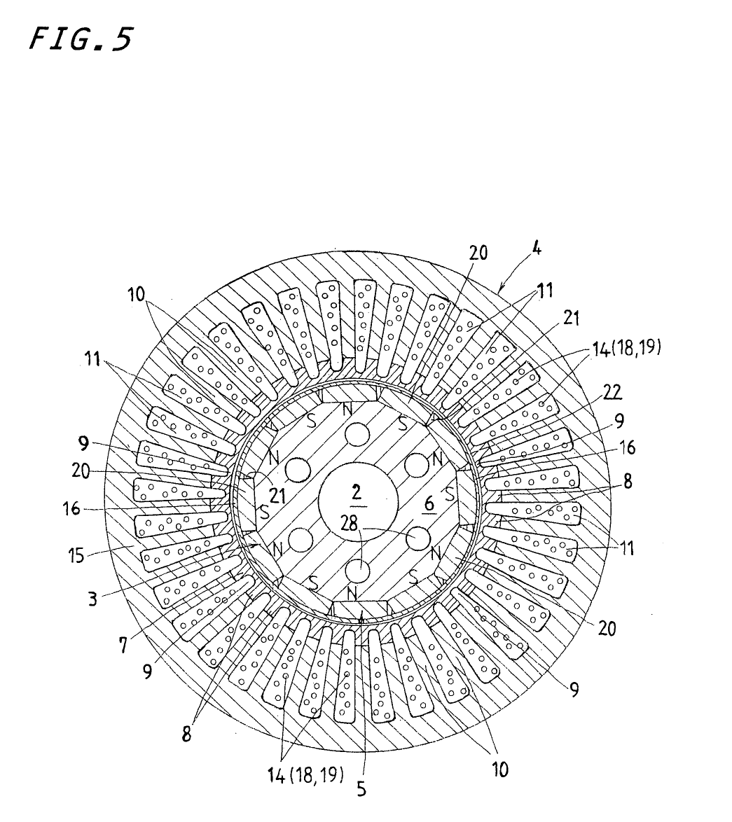

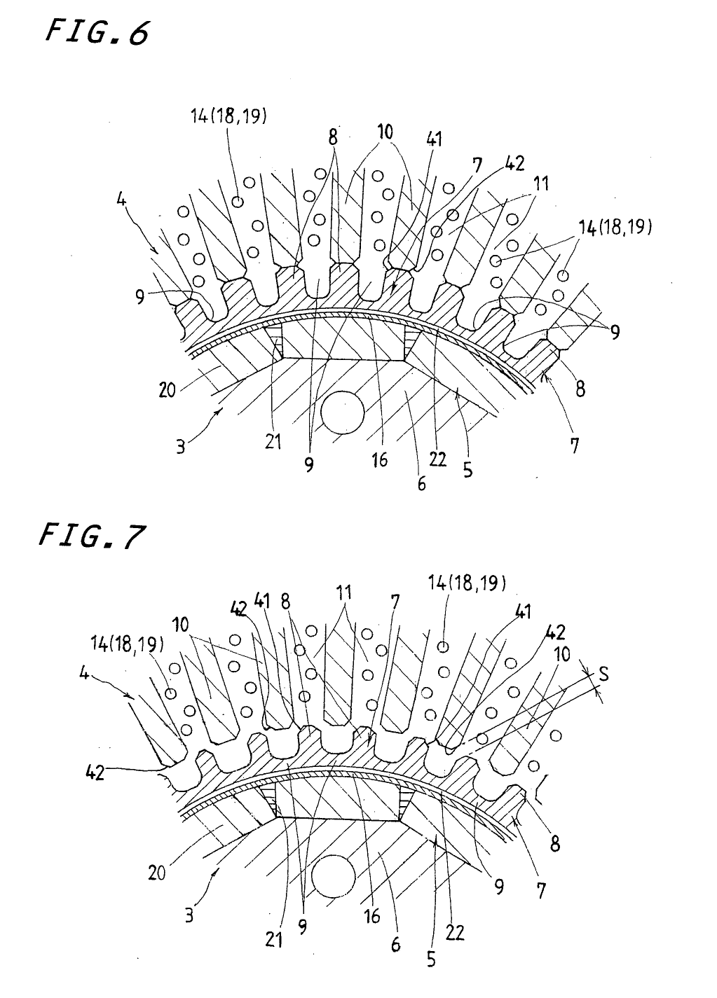

The present permanent-magnet generator with magnetic flux control means, as shown in FIGS. 4 to 7, is in general comprised of a stator housing 1 to accommodate therein a rotor 3 and a stator 4 and also provide a part of magnetic path, a rotating shaft 2 supported in the stator housing 1 for free rotation through axially opposite bearings 13, the rotor 3 having a permanent magnet unit 5 fastened to the rotating shaft 2, the stator 4 being fastened to the stator housing 1 in a way spaced apart from an outside circular surface of the rotor 3, and a flux regulation mechanism having a flux regulator ring 7 installed inside an inside circular surface of the stator 4 and supported through insulating bearings, not shown, in the stator housing 1 for circular movement relatively to the stator 4. The permanent-magnet generator further has an actuator 25 including a solenoid valve, motor, and so on to cause the flux regulator ring 7 to move circularly with respect to the stator 4 depending on driven condition of the rotor 3. The rotor 3 is made at any one of axially opposite ends thereof with a stopper of end plate 35 fastened to the rotating shaft 2 with using any screws, while at another axial end thereof with another retainer plate 34, which is forced towards the stopper when a nut 33 is fastened on the rotating shaft 2 to lock in place the rotor 3 on the rotating shaft 2. Moreover, the rotating shaft 2 is supported for rotation on the stator housing 1 with using the bearings 13 at axially opposite ends thereof, one bearing 13 to each end.

With the permanent-magnet generator of the present invention, the stator 4 fastened inside the stator housing 1 has stator teeth 10 lying sequentially in circular direction in a way separating any two adjacent slots 11 in which coils or windings 14 are laid. The rotor 3 fastened around the rotating shaft 2 supported for rotation in the stator housing 1 has the permanent magnet unit 5 having permanent magnet strips 20, which are juxtaposed around the rotor 3 in a circular direction in a geometry spaced apart from each other. The flux regulator ring 7 lying in a circular clearance 22 defined between the stator 4 and the rotor 3 is actuated to move in circular direction relatively to the stator 4 to regulate the amount of magnetic flux. The stator housing 1 is composed of, for example a pair of axially opposite frame halves and connecting bolts 31 to join together the frame halves. Moreover, the flux regulator ring 7 is supported for rotation in the stator housing 1 with using insulating bearings, not shown, to turn relatively to the stator 4 that is made up of a stator core 15 and stator windings 14 laid on the stator core 15. Inside the stator core 15, there are made the stator teeth 10 lying sequentially in circular direction in a way separating any two adjacent stator slots 11. With the permanent-magnet generator constructed as stated earlier, the windings 14 wound around the stator teeth 10 are composed of, for example an output voltage windings 18 (18U, 18V, 18W) to carry a three-phase current of U-phase, V-phase and W-phase, and flux regulator windings 19 (19U, 19V and 19W).

The flux regulator ring 7 has teeth 8 raised above the ring 7 and positioned around an outside curved surface of the ring 7 at regular intervals corresponding to the stator teeth 10 of the stator 4. The teeth 8 on the flux regulator ring 7 are chamfered at their tooth tip corners to make bevels 41. With the permanent-magnet generator constructed as stated earlier, magnetic paths are created across air gaps between the beveled tips 42 of the stator 4 and the beveled tips 41 of the teeth 8 on the flux regulator ring 7, other air gaps between the top lands of the stator teeth 8 and the bottom lands in the sequential teeth 8, and further other air gaps between the top lands of the teeth 8 on the flux regulator ring 7 and the stator slots 11. In the permanent-magnet generator recited earlier, circular movement of the flux regulator ring 7 relatively to the stator 4 depending on a rpm of the rotating shaft 2 causes the air gaps between them to get increasing or decreasing to regulate the magnetic flux reaching the stator 4, thereby expected to maintain the voltage of the generator within a prescribed voltage range. The rotor 3 is composed of a rotor yoke 6, the permanent-magnet unit 5 positioned around the rotor yoke 6, and a circular reinforcement 16 encircling around the circular outside surfaces of the permanent-magnet unit 5, which are each made up of more than one permanent-magnet strip 20 extended axially and arranged circularly in circumferential direction with nonmagnetic pieces 21 being each interposed between any two adjoining permanent-magnet strips 20. Especially, the permanent-magnet unit 5 is composed of twelve identical permanent-magnet strips 20, each of which is made curved over thirty degrees in circular direction. Moreover, the permanent-magnet strips 20 to make the permanent-magnet unit 5 are positioned in a way the poles on either strip 20 alternates in polarity (N-pole, S-pole) circularly around the rotor 3.

It was impossible or virtually impossible for the permanent-magnet generator constructed as stated earlier to weaken the magnetic force of the permanent magnet strip 20. To cope with this, the permanent magnetic generator has provided therein with the flux regulator ring 7 lying within a circular clearance 22 defined between the disposed between the rotor 3 and the stator 4 to move in circumferential direction relatively to the stator 4. Circular movemen t of the flux regulator ring 7 upon high rpm of the ro tor 3 results in increasing or decreasing the air gaps for magnetic path between the stator teeth 10 and the corresponding teeth 8 around the flux regulator ring 7 to thereby maintain the generated voltage within the acceptable limits. Nevertheless, an amount of magnetic flux regulated by the flux regulator ring 7 would be considered to be, at most, only a matter of 50 to 60%. With the permanent-magnet generator designed to create a prescribed electric power at, for example 1000 rpm, it would be universal to maintain the generated voltage within the prescribed levels before reaching up to 2000 rpm, regardless of whether there is any variation in load and/or rpm. When the rpm of the rotor 3 increases up to 1000 rpm, however, the voltage of the permanent-magnet generator rises to ten-fold higher than the prescribed levels. The flux regulator ring 7 would be only effective to cut the undesirable high voltage down to, at best, a matter of five-fold higher than the prescribed levels. With flux regulating means provided according to the present invention to get the magnetic flux more reducing, the flux regulator winding 19 is laid on the stator 4 in a winding direction reverse to the output voltage winding 18. When switches are turned on to regulate the magnetic flux at high-speed operation range of the engine, an electric current begins incrementally flowing in the flux regulator winding 19 as a load resistance on the output side becomes large under partial load, so that an amount of reverse magnetic field increases automatically. Thus, the more predominant the partial load is, the more the current flowing in the flux regulator winding 19. As a result, the increased reverse magnetic field curbs the generated voltage, maintaining the voltage of the generator within the prescribed voltage limits.

The flux regulating means constructed as stated earlier is well applicable to the permanent-magnet generator that is comprised of the rotating shaft 2 carried for rotation by the stator housing 1, the rotor 3 fastened to the rotating shaft 2 and provided thereon with permanent magnet strips 20 positioned around the rotor 3 in a way spaced apart from each other in the circular direction, the stator 4 mounted inside the stator housing 1 and provided thereon with successive teeth 10 positioned at regular intervals around-the stator 4, the stator winding wound on the teeth 10, and the magnetic flux control means having the flux regulator ring 7 that is installed within the stator housing 1 for circular movement relatively to the stator 4 to increase and decrease the air gaps for flux paths to thereby regulate the magnetic flux passing through the stator 4.

As seen in FIG. 1 to show a preferred embodiment of the permanent-magnet generator constructed according to the present invention, the stator windings 14 wound on the stator teeth 10 are composed of the output voltage windings 18, and the flux regulator windings 19 wound in the direction opposite to the winding direction of the output voltage windings 18. The flux regulator windings 19 are connected with an output voltage terminals, or output lines 17 (17U, 17V, 17W), through flux regulator switches 24 (24U, 24V, 24W), which are turned on when the engine operates at high rpm. Controlling “on-off” operation of the switching means in addition to increasing or decreasing the air gaps for magnetic paths by the magnetic flux control means does more to maintain the voltage of the permanent-magnet generator within the prescribed limits. The output voltage windings 18 have the output lines 17 (17U, 17V, 17W) whose terminals are connected to a load 12 through a three-phase rectifier 23 including Zener diodes. The output lines 17 (17U, 17V, 17W) are also connected with output lines 28 (28U, 28V, 28W) extending from the flux regulator windings 19. With the wiring system between the output voltage winding 18 and the flux regulator winding 19 in the embodiment shown in FIG. 1, a U-phase output line 17U in the output voltage winding 18 is connected with a U-phase output line 28U on same pole in the flux regulator winding 19. Similarly, a V-phase output line 17V in the output voltage winding 18 is connected with a V-phase output line 28V on same pole in the flux regulator winding 19, while a W-phase output line 17W in the output voltage winding 18 is connected with a W-phase output line 28W on same pole in the flux regulator winding 19.

With the permanent-magnet generator constructed as stated earlier, the output voltage winding 18 and the flux regulator winding 19 wound on the stator teeth 10 are each the three-phase winding composed of the U-phase, V-phase and W-phase windings. With the flux regulating means of the present invention, the output voltage windings 18 are shunt at midway locations thereof with intermediate output terminals, or intermediate output lines 29 (29U, 29V, 29W). The output lines 17 (17U, 17V, 17W) for the voltage of the generator have output switches 26 (26U, 26V, 26W) while the intermediate output lines 29 (29U, 29V, 29W) have output-lowering switches 27 (27U, 27V, 27W), which are operated to turn on or off conversely to switching “on-off” of the output switches 26 (26U, 26V, 26W). The output lines 28 (28U, 28V, 28W) extending from the flux regulator windings 19 have flux regulating switches 24 (24U, 24V, 24W). With the flux regulating means constructed as stated earlier, the output switches 26 (26U, 26V, 26W), output-lowering switches 27 (27U, 27V, 27W) and flux regulating switches 24 (24U, 24V, 24W) are all operated to make switching “on-off” in response to both the rpm of the rotor 3 and the variation in the load 12.

In the permanent-magnet generator constructed as stated earlier, the flux regulating switches 24 are turned on under high rpm of the rotor 3 and partial load at the load 12 to create a current for reverse magnetic field, lowering the magnetic flux flowing in the stator 4 through the flux regulator ring 7. The current to establish the reverse magnetic field is controlled automatically to rise incrementally as the load 12 is made reduced. When the rotor 3 is driven at high rpm while the load 12 is under non-loaded condition, the flux regulating means is governed automatically in such a way rendering the resistance at the side of the load 12 infinite to permit all the currents to flow out of the output voltage windings 18 into the flux regulator windings 19 through the flux regulator ring 7, shutting the magnetic flux away from flowing in the stator 4 to thereby eventually stop the provision of the generated voltage.

The output voltage produced by the permanent-magnet generator constructed as stated earlier may be maintained within prescribed limits irrespective of how the rotor 3 with the permanent magnet unit 5 of the permanent magnet strips 20 varies in rpm and/or how the load varies. Even if there is no magnetic flux control mechanism in the permanent-magnet generator, the flux regulator windings 19 are needed to create by themselves the magnetic force opposing head-on against the magnetic force caused by the permanent magnet strips 20 around the rotor 3. This means that large current is required for the flux regulator windings, with generating much heat. In addition, as there is no space to allow the magnetic force escaping, the demagnetization takes place in the permanent-magnet strips 20. When there is installed the flux regulator ring 7, as opposed to the above, the reverse magnetic force developed in the flux regulator windings 19 behaves in a manner that blocks out the magnetic force flowing out of the rotor 3 into the stator 4 to prevent the magnetic force from flowing in the stator 4. Instead, the magnetic force flowing out of the permanent magnet strips 20 around the rotor 3 is allowed to make head for the circular clearance 22 between the stator 4 and the flux regulator ring 7 in circular direction. Thus, there is no risk of demagnetization as well as too much of field current is not required to create sufficient reverse field because the circular clearance provides space to allow the magnetic force escaping there.

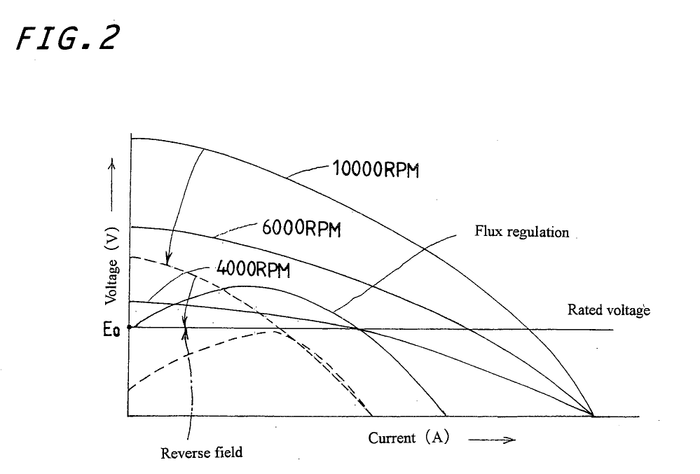

Voltage-current characteristic of the permanent-magnet generator shows that as the rpm rises, the non-loaded voltage increases up to the level that is too great to keep the voltage within prescribed limits by just the flux regulation. With the stranded aspect as stated just above, the resistance on the side of the load 12, although comparatively low under partial loading condition, would come to infinity under non-loaded condition. As a result, all the current flow into the flux regulator windings 19, getting the magnetic force stopping from flowing in the stator 4. This current to create the reverse field has the property of increasing automatically as the load 12 decreases. As seen in FIG. 2, when the rotor 3 is actuated at the speed of 10000 rpm, the flux regulating means of the flux regulator ring 7 makes it possible to lower the output voltage down to the level plotted with a dotted line, but it is impossible to further lower the output voltage down to a prescribed level, or a rated voltage. To cope with this, the flux regulator switches 24 (24U, 24V, 24W) are turned on to develop the reverse field depicted in a dotted line. Thus, the output voltage is lowered by difference in voltage between dotted lines to the prescribed level or the rated voltage.

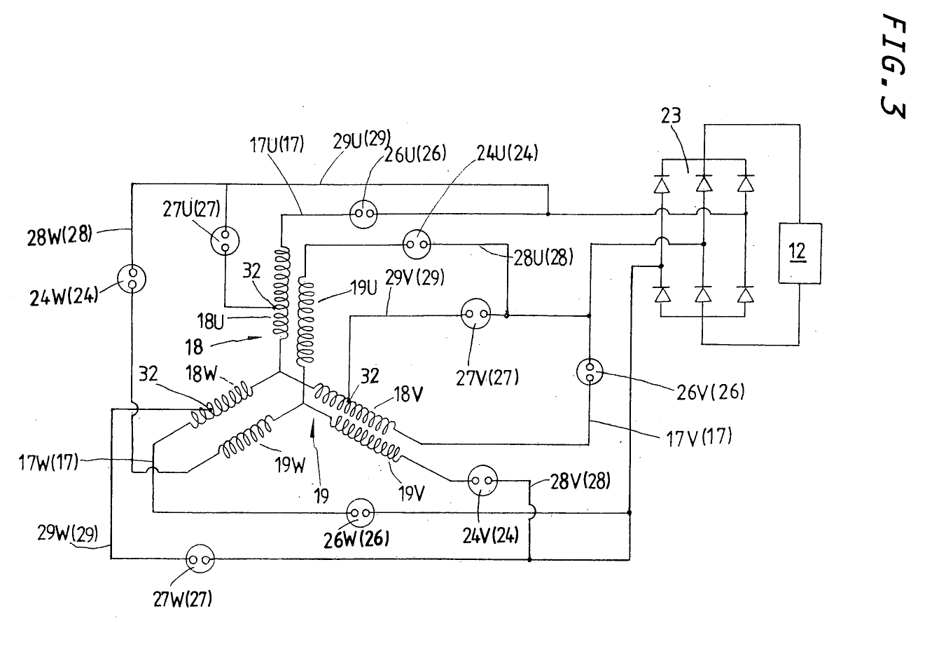

In FIG. 3 there is shown another version of the permanent-magnet generator with the flux regulating means constructed according to the present invention. With the version in FIG. 3, the output voltage windings 18 and the flux regulator windings 19 are connected together in a manner dealing with a time lag when the field is created. Especially, output conductors 17U, 17V and 17W of the phases “U”, “V” and “W” in the output voltage windings 18 are each connected to any backward phase of the output conductors 28U, 28V and 28W of the phases “U”, “V” and “W” in the flux regulator windings 19. If the revolving fields of the rotor 3 will change in phase order of U-phase, V-phase and then W-phase, the U-phase output conductor 17U in the output voltage windings 18 is connected with the backward V-phase output conductor 28W in the flux regulator windings 19, the W-phase output conductor 17W in the output voltage windings 18 is connected with the backward V-phase output conductor 28V in the flux regulator windings 19, and further the V-phase output conductor 17V in the output voltage windings 18 is connected with the backward U-phase output conductor 28U in the flux regulator windings 19. The wiring connections of the output conductors 17 of the output voltage windings 18 with the output conductors 28 of the flux regulator windings 19 as stated earlier are envisaged dealing with the time lag inevitable in the establishment of magnetic field. If the revolving fields of the rotor 3 will change in phase order of U-phase, V-phase and then W-phase, it is preferable to connect phases of the output voltage winding 18 with their backward phases of the flux regulator winding 19 to create the reverse field when a current flows in the stator 4 to keep in check a magnetic force flowing in the stator 4, and later continuing the regulation of the magnetic force with the generated current by itself.

What is claimed is:

1. A permanent-magnet generator; comprising a rotating shaft supported for rotation in a stator housing, a rotor fastened on the rotating shaft and provided with a permanent magnet unit of permanent magnet strips positioned at an interval around the rotor, a stator installed inside the stator housing and provided with windings wound around teeth lying at an interval in a circular direction, a flux regulator ring lying between the stator and the rotor for circular movement relatively to the stator, and a flux regulator means operated to increase or decrease an air gap for flux path between the stator and the flux regulator ring to regulate a magnetic flux flowing in the stator;
wherein the windings wound on the teeth of the stator are each composed of a three-phase output voltage winding wound on the teeth in any one winding direction and a three-phase flux regulating winding wound on the same teeth in another winding direction reverse to the winding direction of the output voltage winding; and
wherein the flux regulating winding has an output line connected to an output line of the output voltage winding through a flux regulator switch, which is operated to turn on or off in response to variations in rpm of the rotor and in load to cause a reverse-field current in the output voltage winding, so that on-off operation of the flux regulator switch conjoins with increase or decrease of the air gap for flux path by the flux regulator means to maintain the output voltage of the generator within a prescribed voltage value.

2. A permanent-magnet generator constructed as defined in claim 1, wherein the output voltage winding is shunt at midway location thereof with an intermediate output terminal, the output line for the output voltage winding has an output switch while the intermediate output line has an output-lowering switch, which is operated to turn on or off conversely to switching “on-off” of the output switch, and wherein the output switch, output-lowering switch and flux regulating switch are all operated to make switching “on-off” in response to both the rpm of the rotor and the variation in the load.

3. A permanent-magnet generator constructed as defined in claim 1, wherein the flux regulator switch is turned on at high rpm of the rotor under partial loaded condition of the load to develop the reverse field current to curb a magnetic flux flowing in the stator through the flux regulator ring, and wherein the reverse field current is regulated automatically to increase as the load decreases.

4. A permanent-magnet generator constructed as defined in claim 3, wherein when the rotator is driven at high rpm while the load is under non-loaded condition, the flux regulating means is governed automatically in such a way rendering a resistance at the load infinite to permit a current to flow out of the output voltage winding into the flux regulator winding through the flux regulator ring, regulating a magnetic force from flowing in the stator so as to decrease an amount of generated power, and then further lowering the flow of the magnetic force down to nothing to thereby eventually stop the output voltage.

5. A permanent-magnet generator constructed as defined in claim 1, wherein the output voltage winding and the flux regulator winding are connected with one another in a manner that a U-phase output line in the output voltage winding is connected with a U-phase output line on same pole in the flux regulator winding, a V-phase output line in the output voltage winding is connected with a V-phase output line on same pole in the flux regulator winding, and further a W-phase output line in the output voltage winding is connected with a W-phase output line on same pole in the flux regulator winding.

6. A permanent-magnet generator constructed as defined in claim 1, wherein the output voltage winding and the flux regulator winding are connected together in a manner that the output lines for poly-phase in the output voltage winding are each connected to the output line for backward phase in the flux regulator winding so as to match with a time lag when the field.

7. A permanent-magnet generator constructed as defined in claim 6, wherein when revolving fields of the rotor change in phase order of U-phase, V-phase and then W-phase, the U-phase output line in the output voltage winding is connected with the backward V-phase output line in the flux regulator winding, the W-phase output line in the output voltage winding is connected with the backward V-phase output line in the flux regulator winding, and further the V-phase output line in the output voltage winding is connected with the backward U-phase output line in the flux regulator winding.
